(19) United States
(12) Patent Application Publication
(10) Pub. No.: US 2011/0273316 A1
(43) Pub. Date: Nov. 10, 2011

(54) METHOD FOR SYNCHRONIZING THE DISPLAY PARAMETERS OF SCREENS IN AN AIRCRAFT COCKPIT

(75) Inventor: Philippe Chabot, Saint Aubin de Medoc (FR)

(73) Assignee: THALES, NEUILLY/SUR/SEINE (FR)

(21) Appl. No.: 13/061,536

(22) PCT Filed: Aug. 20, 2009
(86) PCT No.: PCT/EP2009/060798

§ 371 Date: May 11, 2011

(30) Foreign Application Priority Data
Sep. 2, 2008 (FR) 08 04810

(51) Int. Cl. G01C 23/00

(52) U.S. Cl. 340/971

(57) ABSTRACT

The invention relates to the field of display management of display devices of an aircraft cockpit and particularly to a method of synchronizing display parameters of the display devices and associated monitoring system. The invention includes a method for synchronizing at least one display parameter, such as a luminance parameter, through a series of simple controls of a centralized means of control of the levels of the display parameter. The invention also provides a monitoring system including individual means of monitoring the display parameters and a centralized control means. The invention applies, for example, to instrument panels of aircraft having a plurality of viewing units.

The field of the invention relates to the management of the display devices of an aircraft cockpit. The invention applies particularly to systems for monitoring the display parameters of a network of viewing units. It also relates to a method for synchronizing the display parameters of a plurality of aircraft cockpit viewing devices.

Today's aircraft instrument panels are designed in such a way as to integrate several flat-screen devices so as to implement the functions for interfacing with the avionics systems. The viewing units serve notably the crew in implementing navigation, piloting and communication tasks as well as the monitoring of the aircraft's systems. Typically, the latest commercial models of airplanes comprise between four and eight flat-screen devices.

The viewing devices comprise means for manually and individually adjusting the display parameters, notably the luminance of the screen as well as the display balance, notably between the terrain background or the meteorological data and the symbols.

In the course of a flight, the crew will change these parameters manually as a function of the flight and for a precise task on a particular screen. The crew may also have to modify the configuration of a screen as a function of the siting of said screen in the cockpit for reasons of visual comfort. The readability of the screen may be disturbed on account of the sun's rays illuminating the instrument panel at a particular angle. Moreover, on long-haul flights, the orientation of the sun evolves and induces the crew to individually modify the cockpit viewing units. For night flights, the crew also tailor the luminance of the screens to the ambient lighting of the cabin.

Management of the luminance of all of an aircraft's cockpit viewing devices becomes a major problem in terms of safety and workload. The task becomes particularly laborious when the crew seek to standardize the luminance of the screens throughout the deck to the same configuration. This requires the adjustment of each screen one by one.

Systems for automatically adjusting the luminance of the screens of viewing devices exist, implemented by means of sensors positioned on the front face of the viewing units or the cockpit interior. Despite the effectiveness of these systems, in certain cases the luminance needs to be adjusted manually by means of potentiometers or buttons. These manipulations become problematic since the cockpit arrays vary according to craft and remain difficult to find among the plurality of buttons present on the instrument panel and in certain cases their location is not intuitive. The manipulation to be implemented may also be non-intuitive, so causing additional workload as well as errors in adjustment.

A document is known, an American patent, U.S. Pat. No. 6,590,560, which describes a system making it possible to adjust the luminance level of several screens of a cockpit in synchronization with a signal for adjusting pilot night vision goggles. This document describes a system in which the synchronization signal sets the plurality of screens in the same way. Nonetheless, when these screens comprise different luminance levels, if the operator wishes to set the luminance of the screens to one and the same level, he will have to intervene individually on each screen to set the levels. The synchronization signal only makes it possible to increase or to decrease the luminance level. If a discrepancy in luminance exists between these screens, this discrepancy is maintained.

The aim of the invention is to provide the means for setting one or more display parameters of the viewing units of a cockpit, adjusted to different levels, to one and the same level through a simple and intuitive manipulation on the part of the crew.

More precisely, the invention relates to a method for synchronizing at least one display parameter of at least two viewing units of an aircraft cockpit. The invention also relates to the monitoring system for the viewing units of the aircraft cockpit, this system comprising control means integrated into the cockpit and these means comprising: a centralized means of manual control for incrementing and decrementing the level of said display parameter of all the viewing units of the network and individual means of manual control of incrementation and decrementation for each viewing unit of the level of said display parameter, the display parameter of a first viewing unit being adjusted to a first level and the display parameter of the second viewing unit being adjusted to a second level that may be distinct from the first level, the adjustment levels being bounded between a limit of minimum level and a limit of maximum level.

Advantageously, the synchronization of the levels of the display parameter of the viewing units is implemented through a series of controls with the centralized control means: a first adjustment control positioning the display parameter of all the cockpit viewing units at a third level positioned on one of the two limits, followed by a second control at a fourth synchronization level common to the two viewing units.

Advantageously, the centralized control means is a rotary button comprising a mechanical limit of minimum level and a mechanical limit of maximum level and in that the first control for adjusting the viewing units is implemented by a first sub-control on a first mechanical limit followed by a second sub-control on the second mechanical limit.

Advantageously, the centralized control means comprises a continuous level adjustment without mechanical limits and in that the first control for adjusting the viewing units is implemented by a control of level in a direction of adjustment until the levels of the display parameter of all the cockpit viewing units attain one and the same limit of level.

Advantageously, the first adjustment sub-control is positioned on the adjustment limit of minimum level of the display parameters.

Advantageously, the first adjustment sub-control is positioned on the adjustment limit of maximum level of the display parameters.

Advantageously, for the control of the display parameter, the adjustment settings of the individual control means are masters and the adjustment setting of the centralized control means is slave.

Advantageously, the display parameter is the brightness parameter of the cockpit viewing units.

The invention provides a simple and low-cost solution for synchronizing the display parameters of the viewing units of an aircraft cockpit so as to reduce the workload of the crew and to avoid adjustment errors. The invention will be better understood and other advantages will become apparent on reading the description which follows given by way of nonlimiting example and by virtue of the appended figures among which:

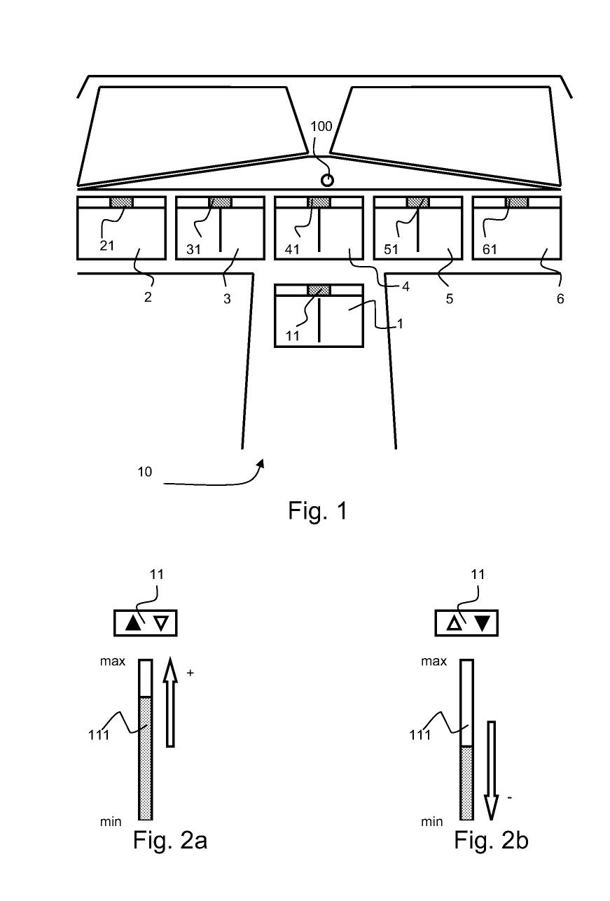

FIG. 1 represents an aircraft cockpit comprising six viewing units with individual controls of the display, positioned on the front face of the viewing units. The centralized control means is located on the instrument panel of the cockpit.

FIG. 2a represents the individual control means for adjusting the luminance of the first viewing unit. The operator implements a control for incrementing the luminance level.

FIG. 2b represents the individual control means for adjusting the luminance of the first viewing unit. The operator implements a control for decrementing the luminance level.

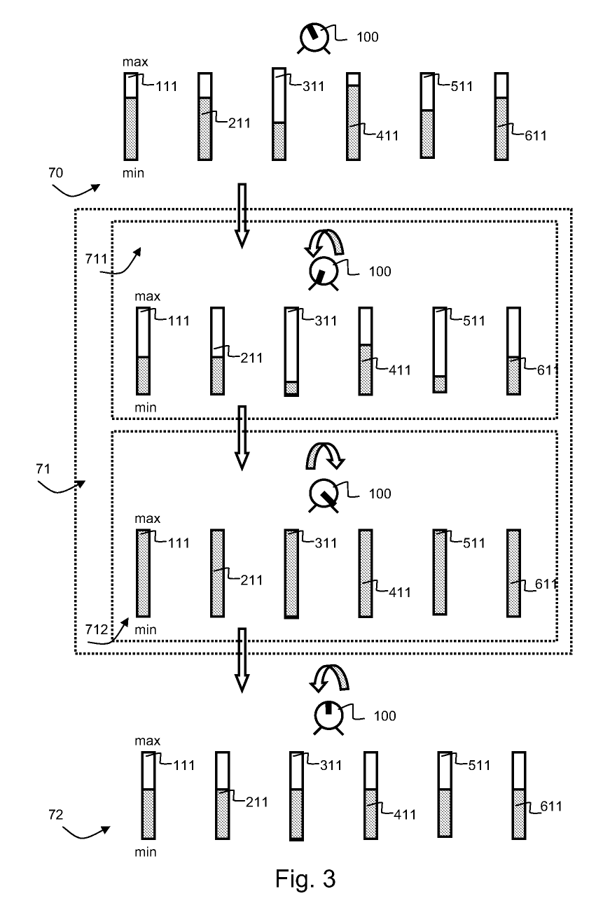

FIG. 3 represents the method for synchronizing the levels of the display parameter of the cockpit viewing units with a rotary centralized means of control comprising stops.

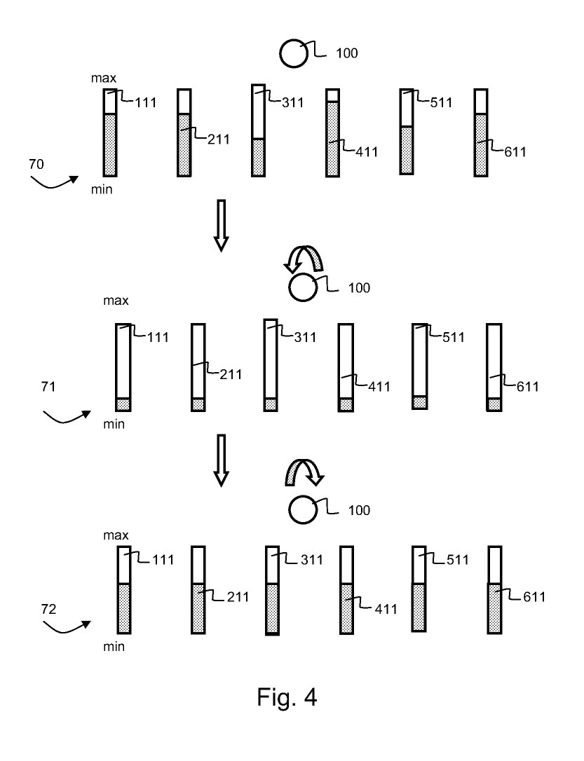

FIG. 4 represents the method for synchronizing the levels of the display parameter of the cockpit viewing units with a centralized means of control without stops.

The arrangement and the number of viewing units on the instrument panel, as illustrated in FIG. 1, does not in any way undermine the spirit and the scope of the invention. However, the invention is particularly beneficial in respect of a network comprising a significant number of viewing units, the task of adjusting the display parameters being indeed more irksome for an operator in the case where the instrument panel comprises numerous viewing units. The cockpit presented hereinbelow comprises six viewing units 1 to 6 and the centralized control button 100. Each viewing unit also comprises an individual adjustment control 11, 21, 31, 41, 51 and 61 for the luminance parameter of the respective screens.

FIGS. 2a and 2b represent the individual means of control of the luminance parameter of the viewing unit 1 of the cockpit.

FIG. 2a illustrates the control law for the control button for the luminance parameter 111 when an incrementation control is implemented by the operator. FIG. 2b illustrates the control law for the control button for the luminance parameter 111 when a decrementation control is implemented by the operator. The control button consists of an incrementation control and a decrementation control, symbolized by mutually inverted triangles. Luminance control is implemented through control of the levels delta-wise, that is to say the level is incremented or decremented and does not provide a level to which the luminance level is set. The individual control of luminance level does not comprise any “min” or “max” limits and may be invoked to infinity. Nonetheless, the luminance level is bounded by a minimum value and a maximum value.

In a first mode of implementation, the centralized control means, shown diagrammatically by a rotary button with stops, comprises a control bounded by two adjustment limits. Preferably, the centralized control means comprises a luminance level adjustment range lying between 0% and 100%.

In a second mode of implementation, the centralized control means may be continuous and without mechanical limits.

This centralized means carries out two functions: delta-wise adjustment of the brightness of all the viewing units and synchronization of the brightness of all the viewing units of the network to one and the same level. The limits of minimum and maximum luminance level serve as level reference point to ensure the synchronization of the display parameters. The synchronization level is selectable between the limits of adjustment of the centralized means of control of level of said display parameter. In this way, the operator easily sets the adjustment of all the viewing units to a level of his choice.

For the control of the display parameter, the adjustment settings of the individual control means, 11 and 21 for example, are masters and the adjustment setting of the centralized control means 100 is slave. As a safety measure and in response to an aeronautical constraint requiring that the viewing devices must not all develop faults at the same time, the architecture of the system for monitoring the display parameters of the cockpit viewing units is designed in such a way that in the case of failure of the centralized control means, notably if it is faulty or if the level control forces the level to a certain value, the level controls for the individual means make it possible to remain master in the monitoring of the display parameters of the cockpit viewing units.

In the course of the flight of the aircraft, the operator modifies the configurations of the display parameters of each viewing unit independently. Depending on the exterior lighting conditions, the operator may have to individually modify the luminance level of the viewing units. He has also been able to modify the image type displayed in accordance with the operations performed involving the successive individual adjustments causing the desynchronization of the display parameters of the viewing units.

FIG. 3 represents the method for synchronizing the luminance parameter of the cockpit viewing units. In this first mode of implementation of the invention, the centralized control means is a rotary button comprising mechanical limits. In the initial cockpit configuration 70, the luminance levels of the viewing units 1 to 6 comprise distinct levels. Luminance levels 111, 211 and 611 are positioned at a first identical level for the three viewing units. Viewing unit 3 is configured to a second luminance level 311 the lowest level within the cockpit viewing network. Viewing unit 4 is configured to a third luminance level 411, the highest level. Viewing unit 5 is configured to a fourth luminance level 511, at a level intermediate between the first level and the second level. In this configuration, it is considered that level 511 is at a level of 45% of the luminance factor, levels 111, 211 and 611 at 60%, level 311 at 30% and level 411 at 90%.

The centralized control means 100 is adjusted to a level intermediate between the minimum and the maximum. Let us consider that this intermediate level has been positioned through a previous manipulation to a value of 45%. Subsequent to the manipulations of the crew on the individual luminance levels during the flight, the viewing units may be configured to different luminance levels from the initial adjustment of the centralized control.

At a given moment of the flight, the crew needs to synchronize all the luminance levels of the viewing units 1 to 6 to 60% for example.

The method consists in implementing a first control 711 of the centralized means 100 by positioning it at the minimum level. The control law for the centralized means is delta-wise, that is to say the luminance level of each screen is decremented by a value equal to the difference of level between the minimum level, 0%, and the intermediate level equal to 45%. This decrementation value is therefore equal to 45%. Luminance levels 111, 211 and 611 are then positioned at 15%. Level 311 is positioned at 0% as is level 511. Level 411 is positioned at 45%.

A second control 712 of the centralized means 100, following the first control 711, consists in positioning it on the maximum level. In this way, an incrementation of level of a value of 100% is implemented and the luminance levels of all the viewing units are positioned at 100% whatever the antecedent luminance level. The luminance levels after the second control of the centralized means then become synchronized to the value 100%.

The method thereafter consists in positioning the control means at a luminance level desired by the operator. FIG. 3 represents the case where the operator wishes to position the luminance level at 60%. Subsequent to implementing the control 72, the luminance levels of all the viewing units are positioned at 60%.

The chaining together of the controls 711 and 712 can also be implemented in reverse so as to synchronize the level of the display parameters. The aim of chaining these two controls together being to synchronize all the levels of the viewing units to the maximum or minimum limit.

FIG. 4 represents the method for synchronizing the luminance parameter of the cockpit viewing units according to another mode of implementation. The control button consists of an incrementation and decrementation of the luminance levels according to the direction of adjustment of the button. By way of example, the centralized control means may be a rotary button not comprising any mechanical limits. The initial configuration 70 of the luminance levels of the cockpit viewing units is similar to the situation presented in the first mode of implementation.

The first adjustment control 71 consists in implementing a decrementation of the luminance levels of the viewing units continuously with the centralized control means 100 until all the luminance levels of the viewing units attain their limit of minimum level. The luminance of the viewing units is then synchronized at this limit.

The method thereafter consists in implementing an incrementation control 72 until the required level.

In this mode of implementation, the synchronization can also be implemented on the maximum luminance level of the viewing units through an incrementation of the levels.

When the value of the centralized control means is modified without attaining the limits, the luminance level of all the viewing units is modified according to the value incremented or decremented by the centralized control means. It makes it possible to raise or lower the luminance level of all the viewing units while retaining the discrepancy which exists between all the luminance levels. Nonetheless the discrepancy is not maintained if the level of a viewing unit attains one of its limits before taking into account the entire decrementation or incrementation, the level then remaining fixed at the limit.

The monitoring system and its method makes it possible to synchronize in an intuitive and fast manner the luminance level of all the cockpit viewing units. The method is applied in respect of one or more display parameters, preferably the luminance level but can also be applied in respect of the image balance parameter. The master/slave architecture between the individual control means and the centralized control means also makes it possible to ensure the level of safety required for aeronautical systems.

1. A method of synchronizing at least one display parameter for the monitoring system of an aircraft cockpit comprising at least two viewing units, the monitoring system comprising control means integrated into the cockpit, said control means comprising a centralized means of manual control for incrementing and decrementing the level of said display parameter of all the viewing units of the network, and individual means of manual control of incrementation and decrementation for each viewing unit of the level of said display parameter, said method comprising:
adjusting the display parameter of a first viewing unit to a first level and the display parameter of the second viewing unit to a second level distinct from the first level, the adjustment levels being bounded between a limit of minimum level and a limit of maximum level, wherein
the synchronization of the levels of the display parameter of the viewing units is implemented through a series of controls with the centralized control means, including a first adjustment control positioning the display parameter of all the cockpit viewing units at a third level positioned on one of the two limits, and a second control at a fourth level common to the two viewing units.

2. The method of synchronization as claimed in claim 1, wherein the centralized control means is a rotary button comprising a mechanical limit of minimum level and a mechanical limit of maximum level and wherein the first control for adjusting the viewing units is implemented by a first sub-control on a first mechanical limit followed by a second sub-control on the second mechanical limit.

3. The method of synchronization as claimed in claim 1, wherein the centralized control means comprises a continuous level adjustment without mechanical limits and wherein the first control for adjusting the viewing units is implemented by a control of level in a direction of adjustment until the levels of the display parameter of all the cockpit viewing units attain one and the same limit of level.

4. The method as claimed in claim 2, wherein the first adjustment sub-control is positioned on the adjustment limit of minimum level of the display parameters.

5. The method as claimed in claim 2, wherein the first adjustment sub-control is positioned on the adjustment limit of maximum level of the display parameters.

6. The method as claimed in claim 3, wherein the adjustment settings of the individual control means are masters and the adjustment setting of the centralized control means is slave.

7. The method as claimed in claim 1, wherein the display parameter is the brightness parameter of the cockpit viewing units.

8. The method as claimed in claim 4, wherein the adjustment settings of the individual control means are masters and the adjustment setting of the centralized control means is slave.

9. The method as claimed in claim 5, wherein the adjustment settings of the individual control means are masters and the adjustment setting of the centralized control means is slave.
